(19) United States
(12) Patent Application Publication
(10) Pub. No.: US 2008/0158142 A1
(43) Pub. Date: Jul. 3, 2008

(54) Method of Increasing Image Bi-Stability and Grayscale Acuracy in an Electrophoretic Display

(75) Inventors: Guofu Zhou, Eindhoven (NL); Eduard Matheus Johannes Niessen, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,202

(22) PCT Filed: Feb. 24, 2005
(86) PCT No.: PCT/IB2005/050674

§ 371 Date: Aug. 21, 2006

(30) Foreign Application Priority Data
Mar. 1, 2004 (EP) 04100804.6

(51) Int. Cl. G02F 1/167; G09G 3/20

(52) U.S. Cl. 345/107; 345/589

(57) ABSTRACT

The present invention relates to an electrophoretic display device (1) and a method of controlling gray level transitions in an electrophoretic display device. The idea of the invention is that, in an electrophoretic device where drive signals (Dr) are applied to display device electrodes (5, 5′) to effect movement of the display particles (8, 9), such that the particles correspond to image information to be displayed, a second electric signal (Ne) is applied to the display device electrodes. This second signal is arranged to decrease the ability of the particles to respond to the drive signal. By employing the second signal in accordance with the invention, more distinct optical states can be attained and the accuracy of the states becomes higher. Thus, the optical states are easier to reproduce due to a more well-defined particle control by means of the drive waveform according to the present invention.

The present invention relates to an electrophoretic display device and a method of controlling gray level transitions in an electrophoretic display device.

Electrophoretic displays are well known in the prior art. The fundamental principle of electrophoretic displays is that the appearance of an electrophoretic media encapsulated in the display is controllable by means of electrical fields. To this end the electrophoretic media typically comprises electrically charged particles having a first optical appearance (e.g. black) contained in a fluid such as liquid or air having a second optical appearance (e.g. white), different from the first optical appearance. The display typically comprises a plurality of pixels, each pixel being separately controllable by means of separate electric fields supplied by electrode arrangements. The particles are thus movable by means of an electric field between visible positions and invisible positions and possibly also intermediate semi-visible positions. Thereby the appearance of the display is controllable. The invisible positions of the particles can for example be in the depth of the liquid.

The international patent application WO 99/53373 discloses an electronic ink display which comprises two substrates. One of the substrates is transparent and the other is provided with electrodes arranged in rows and columns. Display elements (pixels) are associated with intersections of the row and column electrodes. Each display element is coupled to the column electrode via a main electrode of a thin-film transistor (in the following referred to as a TFT). A gate of the TFT is coupled to the row electrode. This arrangement of display elements, TFT's, and row and column electrodes jointly forms an active matrix display device.

Each pixel comprises a pixel electrode which is the electrode of the pixel that is connected via the TFT to the column electrodes. During an image update period or image refresh period, a row driver is controlled to select all the rows of display elements one by one, and the column driver is controlled to supply data signals in parallel to the selected row of display elements via the column electrodes and the TFT's. The data signals correspond to image data to be displayed.

Furthermore, an electronic ink is provided between the pixel electrodes and a common electrode provided on the transparent substrate. The electronic ink is thus sandwiched between the common electrode and the pixel electrodes. The electronic ink comprises multiple small microcapsules, and each microcapsule contains white particles of one charge and black particles of the opposite charge. The particles are suspended in a clear fluid contained in the microcapsule. When applying a positive (with respect to the common electrode) electric field to the pixel electrode located at the “bottom” side of the display, the (positively charged) white particles move to the top of the microcapsule, towards the transparent common electrode in the direction of the display exterior, where they become visible to the viewer of the display. This makes the surface of the display appear white at the location where the white particles are positioned. Consequently, the (negatively charged) black particles move to the bottom of the microcapsules, towards the pixel electrode in the direction of the display interior, where they are not visible to the viewer of the display. By reversing the electrical field applied, the black particles move to the top of the capsule, which now makes the display appear dark at that position. When the electric field is removed, the display remains in the acquired state and thus exhibits a bi-stable character. This electronic ink display with its black and white particles is particularly useful as an electronic book.

Grayscales or intermediate optical states in electrophoretic displays are generally provided by applying voltage pulses, so called drive pulses, to the electrophoretic media for specified time periods, which has the effect that the black and white particles will migrate back and forth in the fluid, and thus the viewer will experience that the display appears to adopt different intermediate optical states, i.e. different levels of gray.

The implementation of grayscales in electrophoretic displays is, however, connected with a number of problems. A fundamental problem is that it is very difficult to accurately control and keep track of the actual positions of the particles in the electrophoretic media, and even minor spatial deviations might result in visible grayscale disturbances. Typically, only the extreme optical states are well defined (i.e. the states where all particles are attracted to one particular electrode). In case a potential is applied which forces the particles towards one of the extreme states, the particles will substantially be collected in that particular state if the potential is applied long enough.

However, in the intermediate optical states there will always be a spatial spread among the particles, and their actual positions will depend upon a number of circumstances which can be controlled only to a certain degree. Consecutive addressing of intermediate gray levels is particularly troublesome. In practice, the actual grayscale is strongly influenced by image history (i.e. the preceding image transitions), the waiting time or the un-powered image holding time (i.e. the time between consecutive addressing signals), temperature, humidity, lateral non-homogeneity of the electrophoretic media etc. It is therefore highly desirable to provide electrophoretic displays offering more well defined gray levels or intermediate optical states. A problem in particular is that, after completion of the drive pulse, the particles continue to move. Thus, the gray levels or intermediate optical states continue to change after the completion of the driving pulse. This results in additional grayscale error.

Typically, the drive pulse is composed of a number of sub-pulses, each of which is applied for one frame period that usually lasts for about 20 ms (the image update/refresh frequency is usually set to 50 Hz), and each sub-pulse is set to a value that for practical reasons is chosen from a limited set of predetermined potential values. The set may e.g. comprise the potential values −15 V, −10 V, −5 V, ±0 V, 5 V, 10 V, 15 V. As a consequence, due to the coarse setting of potential values that may be achieved, a relatively low number of pixel appearances (optical states) may be attained. Thus, the resulting picture quality is relatively low.

The US patent application US 2002/0005832 A1 discloses a method for driving an active matrix electrophoretic display. First, a reset voltage is applied to each pixel electrode of the display in order to initialize the position of the particles provided between the pixel electrodes and a common electrode. Then, a gradation voltage is applied to each pixel electrode to move the particles by the distance corresponding to the gradation to be displayed. Subsequently, the same voltage is applied to the common electrode and each pixel electrode to cancel the electrostatic field and fix the particles in a desired position. However, US 2002/0005832 A1 states that it can take considerable time for particles to become stationary depending on the level of fluid resistance encountered in the dielectric fluid in which the particles are situated. This will cause fluctuations in display brightness. Therefore, a brake voltage is applied to the particles, which brake voltage applies an electrostatic field to the particles which is acting in the opposite direction compared to the field caused by the gradation voltage. The value of the brake voltage is, for one thing, dependent on the kinetic energy of the particles. A brake voltage generation part is provided with a table in which brake voltage data and image data having values corresponding to those of said brake voltage data are memorized. In this way, the brake voltage data is acquired by accessing the table.

A problem with US 2002/0005832 A1 is, however, that in order to provide an accurate brake voltage, many factors must be considered, for example the resistance of the dielectric fluid, the image history, the gradation to be effected, the temperature etc. This makes the acquirement of the brake voltage data rather complex. Another problem is that since a large amount of energy is required to increase the movement the particles in order to create the desired gradation, it is not very energy efficient to apply energy to the particles in order to brake said movement.

It is an object of the present invention to provide, notwithstanding the fact that relatively long frame periods are employed and relatively low-bit drive signals are used, an electrophoretic display device that is able to display high quality pictures.

A further object of the present invention is to provide a smooth and efficient solution to the problem that particles continue to move after the completion of the driving pulse.

These objects are attained by an electrophoretic display device comprising an electrophoretic medium comprising charged particles, a plurality of picture elements, electrodes associated with each picture element and arranged to receive drive signals and drive means arranged to control the drive signals supplied to the electrodes, which drive signals are provided to create a potential difference across each picture element to bring the particles into a position corresponding to image information to be displayed in accordance with claim 1. These objects are further attained by a method of controlling gray level transitions in an electrophoretic display device, the method comprising the steps of supplying a drive signal to display device electrodes associated with each picture element of the display device and controlling the drive signal supplied to the display device electrodes such that the drive signal provided to each picture element creates a potential difference across the picture element to bring charged particles of the display device into a position corresponding to image information to be displayed in accordance with claim 12. Preferred embodiments are defined by the dependent claims.

According to a first aspect of the invention, the drive means of the electrophoretic display device is further arranged to apply a second electric signal to the electrodes, which second electric signal decreases the ability of the particles to respond to the drive signal.

According to a second aspect of the invention, a second electric signal is applied to the display device electrodes, which second electric signal decreases the ability of said particles to respond to the drive signal.

The idea of the invention is that in order to display a desired image, a drive signal is applied to all or a portion of picture electrodes, which electrodes define the picture elements (pixels) of the display. The drive signal has an energy, defined as the product of the drive signal voltage and the time during which the drive signal voltage is applied, sufficient to bring charged particles comprised in the electrophoretic display into a position which corresponds to image information to be displayed. This may be an intermediate optical state in-between the two extreme optical states, in which particles of one polarity is located at the pixel electrode and particles of the opposite polarity is located at an opposing counter electrode. The required energy of the drive pulse depends on the desired transition of the optical state.

The drive signal supplied to the pixel electrodes applies an electric field to the corresponding pixels to create a potential difference across said pixels in order to effect the movement of particles.

A second electric signal is applied to the pixel electrodes, which second signal decreases the ability of the particles to respond to the drive signal. This results in a change in position of the particles that correspond to the pixels which is subject to the drive signal. However, for a given signal energy, the change in position of the particles is smaller when the second signal and the drive signal is applied compared to the change in position when only the drive signal is applied and no second signal is applied.

Consequently, the change in appearance of the pixels that is subject to the drive signal depends on when, during the duration of the drive signal, the second signal is applied, i.e. at which instant of time during the duration of the drive signal the second signal is applied. By superimposing the second signal on the drive signal at different instants of time in the duration of the drive signal, a relatively large number of pixel grayscales can be achieved, even when the frame period is relatively large and the number of different voltage values that the drive signal can be set to is relatively low.

By employing the second electric signal in accordance with the present invention more distinct optical states can be attained and the accuracy of the states becomes higher. Thus, the optical states are easier to reproduce, due to a more well-defined control of the particles by means of the drive waveform according to the present invention, in which the second electric signal is applied.

The invention is based upon the insight that the appliance of the second electric signal to the pixel electrodes surprisingly seems to result in a uniform distribution of ions around the particles, which has the effect that the ability of the particles to respond to the drive signal is decreased.

In an embodiment of the present invention, the second electric signal is applied at the second half of the duration of the applied drive signal.

This has the advantageous effect that the ability of the particles to respond to the drive signal gradually will decrease, starting from the second half of the drive signal (i.e. from the instance when the second signal is applied). As this ability gradually decreases, the particles gradually becomes more insensitive to the drive signal. The movement of the particles will thus gradually decline towards the end of the drive signal. At the completion of the drive signal, i.e. when the drive signal is disabled, the particles have stopped. Consequently, the desired effect has been reached, i.e. after completion of the drive pulse, the movement of the particles have ceased. Thus, the desired gray levels or intermediate optical states have been reached in a straightforward and smooth manner. Moreover, ceasing of the particle movement has been effected without applying energy to the pixel electrodes after the completion of the drive signal, which results in a more energy efficient method to cease particle movement.

According to an embodiment of the invention the second electric signal is applied at the end of the duration of the drive signal. Since the second signal is slowing the image update process, it is preferable to apply the second signal at the second half of the duration of the drive signal or even better close to the end of the duration of the drive signal. This is advantageous, as the grayscale accuracy is improved without causing large delays in the image update.

According to another embodiment of the present invention, the drive signal is distributed around the second signal. It is favorable if the drive means are further able to supply, for each picture element, a further signal to decrease the ability of the particles to respond to the potential difference of the drive signal before the final part of said drive signal. The drive signal is thus divided into at least two parts and comprises at least two pulses to decrease the ability of the particles to respond to the potential difference of the drive signal. As a result, a relatively very large number of appearances (optical states) of the picture elements can be achieved.

According to still another embodiment of the invention, the second electric signal comprises a sequence of pulses, in which sequence the polarity of the pulses is alternating. Further, the amplitude of the pulses decreases with time. This further has the advantage that the smoothness, with which the second signal decreases the ability of the particles to respond to the drive signal, increases.

According to yet another embodiment of the invention, the second pulse is arranged to be substantially devoid of a DC component. This embodiment is advantageous, as the total energy of the superimposed signals, i.e. the drive signal and the added second electric signal, is equivalent to the energy of the drive signal when no second signal is applied.

In a further embodiment of the invention, the polarity of the superimposed signals remains the same for the complete duration of the second signal. In this manner, the efficiency of the second signal to decrease the ability of the particles to respond to the potential difference of the drive pulse is enhanced.

Further features of, and advantages with, the present invention will become apparent when studying the appended claims and the following description. Those skilled in the art realize that different features of the present invention can be combined to create embodiments other than those described in the following.

The preferred embodiments of the present invention will be described in detail with reference made to the accompanying drawings, in which:

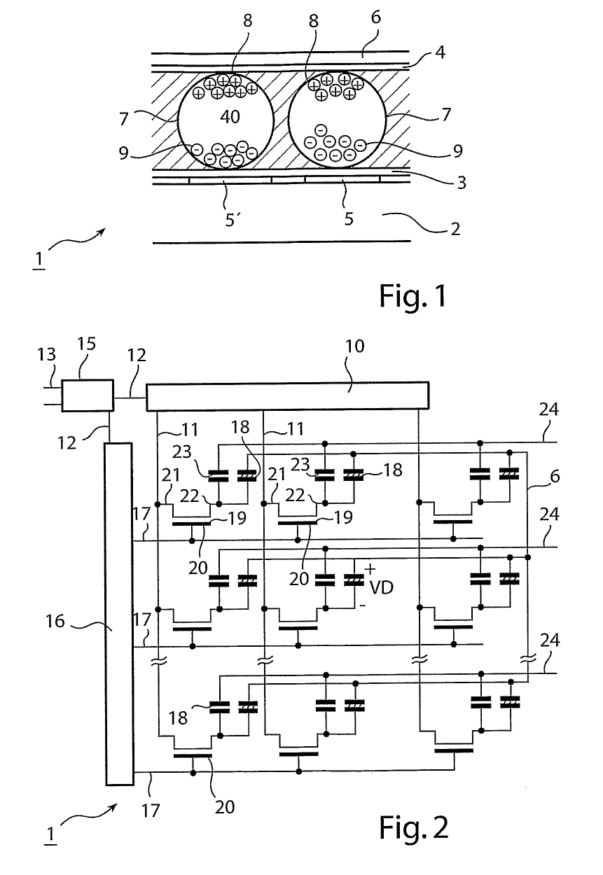

FIG. 1 shows a diagrammatical cross-section of a portion of a display device according to an embodiment of the invention;

FIG. 2 shows an equivalent circuit diagram of a portion of the display device;

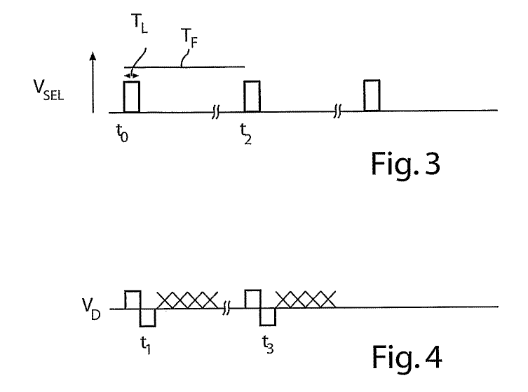

FIGS. 3 and 4 shows control signals and drive signals of the display device;

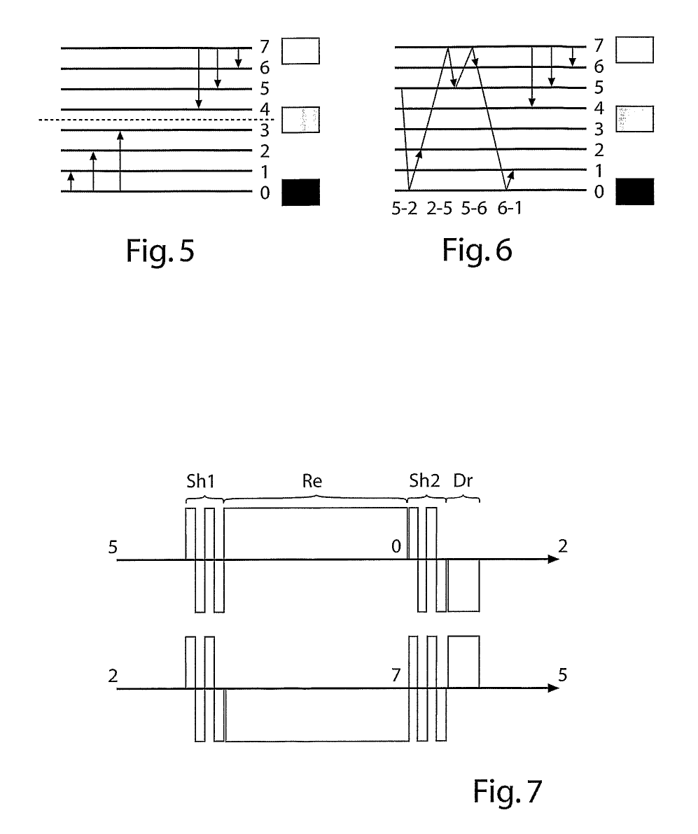

FIG. 5 illustrates gray level states in the display device;

FIG. 6 illustrates gray level transitions in the display device;

FIG. 7 illustrates drive signal waveforms for two different gray level transitions according to the present invention;

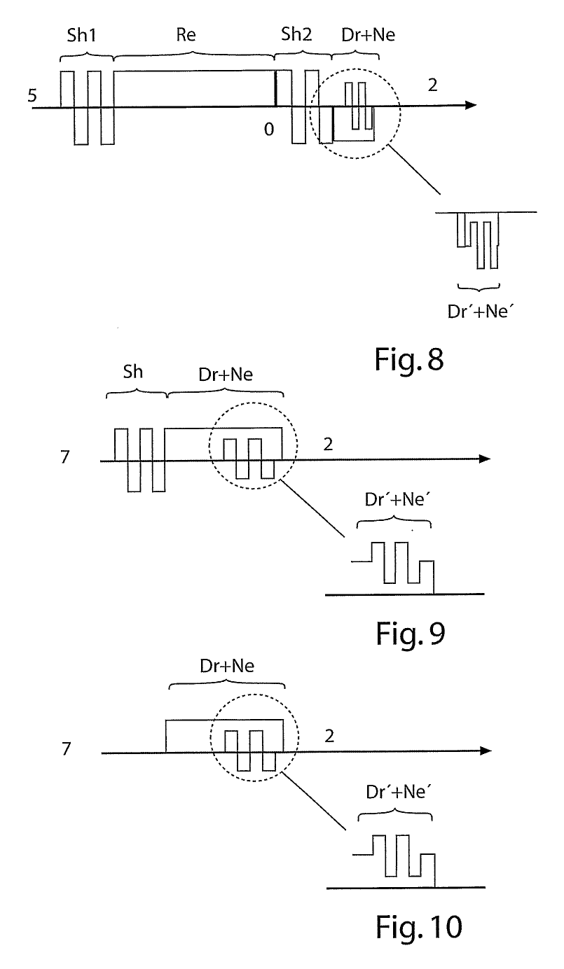

FIG. 8 shows a drive signal comprising a neutralizing signal in accordance with an embodiment of the present invention;

FIG. 9 shows a drive signal comprising a neutralizing signal in accordance with another embodiment of the present invention;

FIG. 10 shows a drive signal comprising a neutralizing signal in accordance with a further embodiment of the present invention;

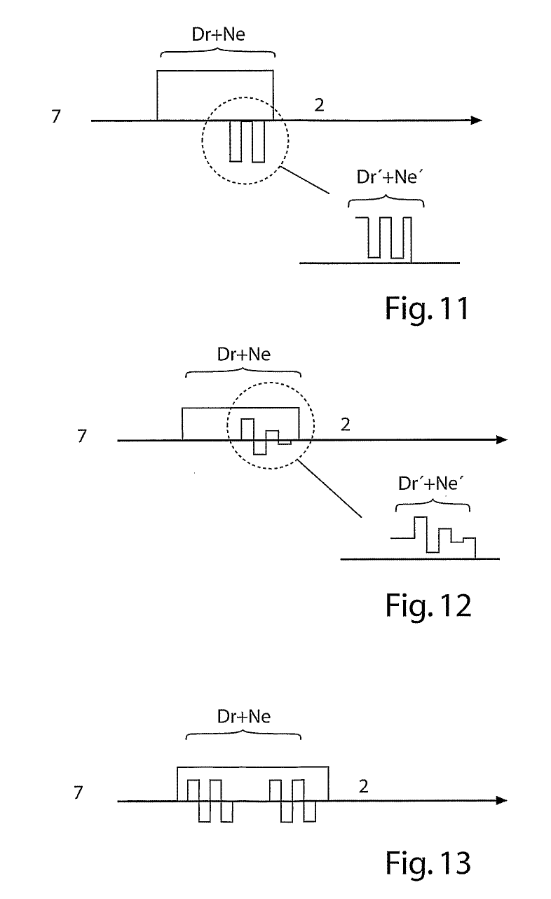

FIG. 11 shows a drive signal comprising a neutralizing signal in accordance with yet a further embodiment of the present invention;

FIG. 12 shows a drive signal comprising a neutralizing signal in accordance with still another embodiment of the present invention; and

FIG. 13 shows a drive signal comprising a neutralizing signal in accordance with yet another embodiment of the present invention.

FIG. 1 shows a cross section of a portion of an electrophoretic display device 1, which for reasons of simplicity only shows a few picture elements. The display device comprises a base substrate 2, an electrophoretic film provided with electronic ink, which is present between two transparent substrates 3, 4. One of the substrates 3 is provided with transparent pixel electrodes 5, 5′ and the other substrate 4 with a transparent counter electrode 6. The counter electrode may also be segmented. The electronic ink comprises multiple microcapsules 7 of about 10 to 50 microns. Each microcapsule 7 comprises negatively charged white particles 8 and positively charged black particles 9 suspended in a fluid 40.

A drive means 10 (see FIG. 2) is arranged to supply drive signals Vdr to the pixel electrodes 5, 5′ to apply an electric field to some or all of the pixels 18 (FIG. 2), i.e. to create a potential difference across the pixels. When the pixel voltage VD across the pixel is supplied as a negative drive voltage Vdr (see for example FIG. 7) to the pixel electrodes 5, 5′ with respect to the counter electrode 6, an electric field is generated which moves the white particles 8 to the side of the microcapsule 7 directed to the counter electrode 6 and the pixel appear white to the viewer. Note that VD denotes the total signal waveform and can, as will be shown later, comprise more signals in addition to the drive signal Vdr.

Simultaneously, the black particles 9 move to the opposite side of the microcapsule 7 where they are hidden to the viewer. By applying a positive drive voltage Vdr to the pixel electrodes 5, 5′ with respect to the counter electrode 6, the black particles 9 move to the side of the microcapsule 7 directed to the row electrodes 6 and the pixel appears dark to a viewer. When the electric field is removed the particles remains in the acquired state and the display exhibits a bi-stable character and consumes substantially no power.

Drive signals Vdr is applied to the pixel electrodes 5, 5′ to control the positions of the particles 8, 9 in the fluid 40 in order to attain desired image information on the display. When the particles are in one of the intermediate positions, i.e. in between the pixel electrodes 5, 5′ and the counter electrode 6, the pixels have one of the intermediate appearances, e.g. light gray, middle gray and dark gray. The drive means 10 is arranged to control the voltage applied to the electrodes 5, 5′, i.e. to control the potential difference across the pixels.

FIG. 2 shows an equivalent circuit of a picture display device 1 comprising an electrophoretic film laminated on a base substrate 2 provided with active switching elements 19, a row driver 16 and a column driver 10. Preferably, the counter electrode 6 is provided on the film comprising the encapsulated electrophoretic ink, but could alternatively be provided on a base substrate in the case of operation using in-plane electric fields. The display device 1 is driven by the active switching elements, which in this example comprise thin film transistors 19. The display device comprises a matrix of picture elements associated with intersections of row or select electrodes 17 and column or data electrodes 11. The row driver 16 consecutively selects the row electrodes 17, while the column driver 10 provides data signals via the column electrodes 11 to the pixels associated with the selected row electrode. Preferably, a processor 15 first processes incoming data 13 into the data signals to be provided by the column electrodes. Mutual synchronization between the column driver 10 and the row driver 16 takes place via drive lines 12.

Select signals from the row driver 16 select the pixel electrodes 22 via the thin film transistors 19 whose gate electrodes 20 are electrically connected to the row electrodes 17 and the source electrodes 21 are electrically connected to the column electrodes 11. A data signal present at the column electrode 11 is transferred to the pixel electrode 22 of the pixel 18 coupled to the drain electrode via the TFT. Thus, a data signal applied to the column electrode is transferred to the pixel electrode 22 of the pixel 18 coupled to the TFT drain electrode if the TFT is selected by means of an appropriate signal level on its gate. In the embodiment shown, the display device of FIG. 1 also comprises an additional capacitor 23 at the location at each pixel 18. The additional capacitor 23 is connected between the pixel electrode 22 and one or more storage capacitor lines. Instead of using TFT's, other switching elements can be applied such as diodes, MIM's, etc.

FIGS. 3 and 4 show drive signals of a conventional display device. At the instance t0, a row electrode 17 is energized by means of a selection signal Vsel, while simultaneously drive signals Vdr are supplied to the column electrodes 11. After a line selection time tL has elapsed, a subsequent row electrode 17 is selected at the instant t1, etc. After some time, for example, a frame time, usually 16.7 ms or 20 ms (resulting in an image update/refresh frequency of 60 Hz and 50 Hz, respectively), said row electrode 17 is energized again at instant t2 by means of a selection signal Vsel, while simultaneously the drive signals Vdr are presented to the column electrode 11. After a selection time tL has elapsed, the next row electrode is selected at the instant t3. Because the bi-stable character of the display device, the electrophoretic particles remains in their selected state when the electric field is removed, and the repetition of data signals can be halted after a required number of frame updates when the desired gray level has been obtained. Usually, the image update time is several frame periods long.

In FIG. 5, the gray level states of a black and white display providing a black (0), a white (7), and six intermediate gray levels (1-6) are illustrated. The arrows indicate the reset state, in which state the position of the particles provided between the pixel electrodes and the counter electrode is initialized, for the respective gray level (states 1-3 having state 0 as reset state and states 4-6 having state 7 as reset state). The chosen reset state is the state that is closest to the desired transition to reduce flicker in the image.

Furthermore, FIG. 6 illustrates addressing signals for the consecutive addressing of states 2-3-2-3-2. As can be seen, state 0 is repeatedly used as reset state, which minimizes flicker.

Drive waveforms that may be used for a transition from state 5 to state 2 (upper waveform) and from state 5 to state 2 (lower waveform) via reset state 0 and 7, respectively, are shown in FIG. 7. For example, each waveform can consists of a first shaking signal Sh1, a reset signal Re, a second shaking signal Sh2 and a drive signal Dr. The shaking signal increases the mobility of the particles such that the subsequent reset (or drive) signal has an immediate effect. The shaking signal might comprise only one voltage pulse or a number of voltage pulses, and can be applied before the drive signal and/or before the reset signal. The shaking signal has an energy sufficient to release particles present in one of the extreme states, but insufficient to enable the particles to reach the other one of the extreme positions. The shaking signal is described in detail in the pending European patent application no. 02077017.8.

The approach of using reset states to initialize the particles is known as the rail-stabilized approach, which means that the gray levels are always addressed via a well defined reset state, typically one of the extreme states (i.e. rails).

According to an embodiment of the invention, which is illustrated in FIG. 8, the rail-stabilized driving scheme is employed, i.e. the grayscale image is obtained via one of the two extreme optical states. An example of a drive waveform according to the present invention is shown, in which a transition from state 5 to state 2 is effected. The drive waveform consists of a first shaking signal Sh1, a reset signal Re, a second shaking signal Sh2 and a drive signal Dr, on which a neutralizing signal Ne is superimposed. The neutralizing signal, which in this embodiment comprises four pulses with alternating polarity, is applied during the second half of the duration of the drive signal. From the second half of the drive signal, when the neutralizing signal is applied, creating the signal Dr′+Ne′, the ability of the particles to respond to the drive signal gradually will decrease. As this ability gradually decreases, the particles gradually becomes more insensitive to the drive signal. The movement of the particles will thus gradually decline towards the end of the drive signal. At the completion of the drive signal, i.e. when the drive signal is disabled, the particles have stopped. Consequently, the desired effect has been reached, i.e. after completion of the drive pulse, the movement of the particles have ceased. The state 2 appearance, i.e. a dark gray level, obtained in this embodiment has a somewhat darker gray level than the one that would have been obtained using the drive waveform illustrated in FIG. 7. The use of the neutralizing signal results in more distinct optical states and this leads to a higher accuracy in the optical states. Thus, the optical states are easier to reproduce, due to a more well-defined control of the particles by means of the drive waveform according to the present invention.

Note that the neutralizing signal superimposed on the drive signal will have the appearance of the signal denoted Dr′+Ne′ in FIG. 8.

According to another embodiment of the invention shown in FIG. 9, another driving scheme can be employed, in which no reset signals are used. An example of a drive waveform according to the present invention is shown, in which a transition from state 7 to state 2 is effected. The drive waveform consists of a shaking signal Sh and a drive signal Dr, on which a neutralizing signal Ne is superimposed. The neutralizing signal, which in this embodiment comprises four pulses with alternating polarity, is applied towards the end the duration of the drive signal.

When the neutralizing signal is applied, the ability of the particles to respond to the drive signal gradually will decrease, as described in the previous embodiment. With gradually decreasing ability to respond, the particles gradually become less influenced by the drive signal. Both during the neutralizing signal and after the neutralizing signal is completed, the particles respond slower to the drive signal than before the neutralizing signal is applied. For this reason, state 2 can be made darker than if the neutralizing signal were not applied. In this manner, the creation of still more gray levels is enabled. Finally, when the drive signal is disabled, the particles have stopped, and the movement of the particles have ceased. The use of the neutralizing signal results in more distinct optical states and this leads to a higher accuracy in the optical states in this embodiment as well.

In yet another embodiment shown in FIG. 10, where neither shaking pulses nor reset pulses are employed, the state 2 appearance, i.e. a dark gray level, will have a still darker gray level than the one that would have been obtained using a drive waveform comprising shaking pulses. The use of the neutralizing signal results in even more distinct optical states and higher optical accuracy.

In a further embodiment shown in FIG. 11, due to the fact that the neutralizing signal contains a negative DC component sufficiently large to prevent the neutralizing signal from adopting a positive value, the overall peak voltage level remains the same as in the case where only a drive signal is applied, resulting in the fact that the peak power level is kept low, in addition to the previously mentioned advantages.

In still a further embodiment of the invention shown in FIG. 12, the amplitude of the pulses of the neutralizing signal decreases with time. This has the advantage that the smoothness with which the neutralizing signal decreases the ability of the particles to respond to the drive signal increases. In addition, this will result in an even more uniform distribution of ions around the charged particles, thereby attaining a further reduction of the ability of the particles to respond to the drive signal.

According to another embodiment of the present invention shown in FIG. 13, the drive signal is distributed around the second signal. It is favorable if the drive means are further able to supply, for each picture element, a further signal to decrease the ability of the particles to respond to the potential difference of the drive signal before the final part of said drive signal. The drive signal is thus divided into at least two parts and comprises at least two pulses to decrease the ability of the particles to respond to the potential difference of the drive signal. As a result, a relatively very large number of appearances (optical states) of the picture elements can be achieved.

Experiments that have been undertaken show that when a neutralizing signal, which comprises pulses with alternating polarity, is superimposed on a drive signal having an amplitude of 15V, the amplitude of the neutralizing signal has a great impact on the ability of the particles to respond to the drive signal. If a neutralizing signal that has an amplitude varying between −14 V and 14 V is superimposed, which results in a total signal varying between 1 V and 29 V, the ability of the particles to respond to the drive signal is greatly decreased compared to a case where a neutralizing signal that has an amplitude alternating between −5 V and 5 V is employed, which results in a total drive signal varying between 10 V and 20 V.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. An electrophoretic display device (1) comprising:
an electrophoretic medium (40) comprising charged particles (8, 9);
a plurality of picture elements (18);
electrodes (5, 5′) associated with each picture element and arranged to receive drive signals (Dr); and
drive means (10) arranged to control the drive signals supplied to the electrodes, which drive signals are provided to create a potential difference (VD) across each picture element to bring the particles into a position corresponding to image information to be displayed, the display device being characterized in that:
said drive means is further arranged to apply a second electric signal (Ne) to the electrodes, which second electric signal decreases the ability of said particles to respond to the drive signal.

2. The display device (1) according to claim 1, wherein the energy of the second electric signal (Ne) is controlled by the drive means (10) such that said second signal does not drive the particles (8, 9) into an extreme position near the electrodes (5, 5′, 6).

3. The display device (1) according to claim 1, wherein the second electric signal (Ne) is superimposed on the drive signal (Dr).

4. The display device (1) according to claim 1, wherein the superimposed signal (Dr′+Ne′) is arranged such that its polarity remains the same for the complete duration of the second electric signal (Ne).

5. The display device (1) according to claim 1, wherein the drive signal (Dr) is distributed around the second electric signal (Ne).

6. The display device (1) according to claim 1, wherein the second electric signal (Ne) is applied during the second half of the duration of the drive signal (Dr).

7. The display device (1) according to claim 1, wherein the second electric signal (Ne) is applied at the end of the duration of the drive signal (Dr).

8. The display device (1) according to claim 1, wherein the second electric signal (Ne) comprises a sequence of pulses, in which sequence the polarity of the pulses is alternating.

9. The display device (1) according to claim 8, wherein the energy of a pulse in the sequence is essentially equal to the energy of any other pulse in said sequence.

10. The display device (1) according to claim 8, wherein the amplitude of the pulses decreases with time.

11. The display device (1) according to claim 8, wherein the drive means (10) removes any direct current component from the second electric signal (Ne) before applying it to the electrodes (5, 5′).

12. A method of controlling gray level transitions in an electrophoretic display device (1), the method comprising the steps of:
supplying a drive signal (Dr) to display device electrodes (5, 5′) associated with each picture element (18) of the display device;
controlling the drive signal supplied to the display device electrodes such that the drive signal provided to each picture element creates a potential difference (VD) across said picture element to bring charged particles (8, 9) of the display device into a position corresponding to image information to be displayed, the method being characterized in that it comprises the step of:
applying a second electric signal (Ne) to the display device electrodes, which second electric signal decreases the ability of said particles to respond to the drive signal.

13. The method according to claim 12, further comprising the step of:
controlling the energy of the second electric signal (Ne) such that said second signal does not drive the particles (8, 9) into an extreme position near the display device electrodes (5, 5′, 6).

14. The method according to claim 12, further comprising the step of:
superimposing the second electric signal (Ne) on the drive signal (Dr).

15. The method according to claim 12, wherein the superimposed signal (Dr′+Ne′) is arranged such that its polarity remains the same for the complete duration of the second electric signal (Ne).

16. The method according to claim 12, further comprising the step of:
distributing the drive signal (Dr) around the second electric signal (Ne).

17. The method according to claim 12, wherein the second electric signal (Ne) is applied during the second half of the duration of the drive signal (Dr).

18. The method according to claim 12, wherein the second electric signal (Ne) is applied at the end of the duration of the drive signal (Dr).

19. The method according to claim 12, wherein the second electric signal (Ne) comprises a sequence of pulses, in which sequence the polarity of the pulses is alternating.

20. The method according to claim 19, wherein the energy of a pulse in the sequence is essentially equal to the energy of any other pulse in said sequence.

21. The method according to claim 19, wherein the amplitude of the pulses decreases with time.

22. The method according to claim 19, further comprising the step of:
removing any direct current component from the second electric signal (Ne) before applying it to the display device electrodes (5, 5′).
